(19) United States
(12) Patent Application Publication
(10) Pub. No.: US 2014/0320258 A1
(43) Pub. Date: Oct. 30, 2014

(54) KEY WRITING DEVICE AND KEY WRITING METHOD THEREOF

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: DONG-YAN LI, Shenzhen (CN); BING ZHOU, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/260,470

(22) Filed: Apr. 24, 2014

(30) Foreign Application Priority Data
Apr. 26, 2013 (CN) 2013101485274

(51) Int. Cl. G05B 1/01

(52) U.S. Cl. CPC G05B 1/01
USPC 340/5.22

(57) ABSTRACT

A key writing device electrically connected to an electronic device for automating the writing of multiple keys for activating one or more functions of the electronic device, via a key writer. The key writing device includes a storage storing multiple keys, at least two of the keys to be written into the electronic device are selected from the storage and are packed into a key package. The package including the at least two keys is then written into the electronic device using the key writer.

### FIELD

The present disclosure relates to a key writing device and a method thereof for controlling a key writer to write a plurality of keys into an electronic device for activating functions of the electronic device.

### BACKGROUND

One or more security keys used for activating specific functions of an electronic device need to be written into the electronic device before the electronic device is released from the factory. In a typical security key writing method, a lot of time is spent writing each of the keys into the electronic device. This represents low manufacturing efficiency.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a key writing device for controlling a key writer to write a plurality of keys into an electronic device.

FIG. 2 is a schematic diagram of a user interface of the key writing device.

FIG. 3 is a flowchart of a key writing method implemented by the key writing device.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

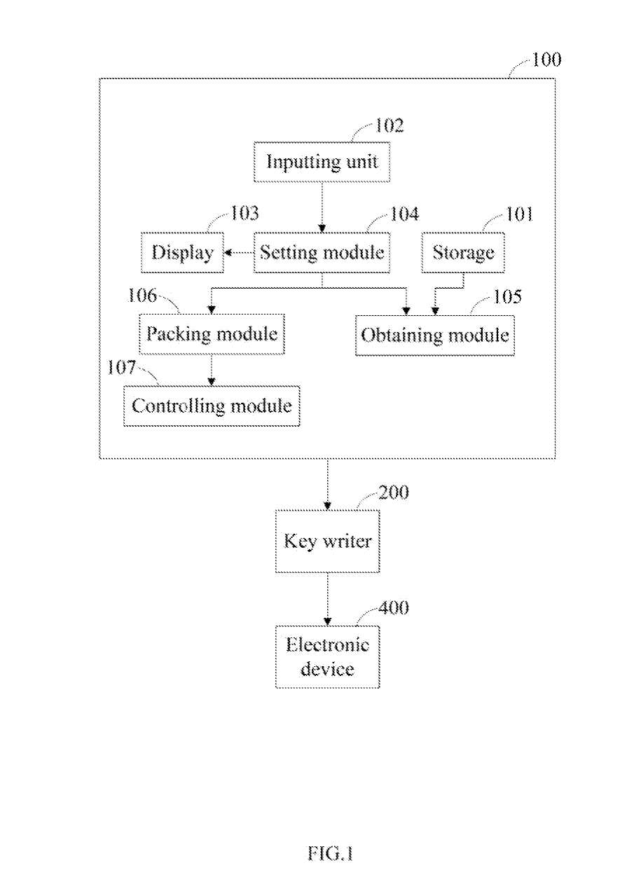

FIG. 1 shows a block diagram of an embodiment of a key writing device 100. The key writing device 100 is connected to an electronic device 400 via a key writer 200, for writing a plurality of keys into the electronic device 400. The key writing device 100 can be an independent device or a component integrated in a computer. The electronic device 400 can be a Notebook, a portable DVD player, a tablet personal computer, a game player, or the like.

The key writing device 100 includes a storage 101, an inputting unit 102, a display 103, a setting module 104, an obtaining module 105, a packing module 106, and a controlling module 107.

The storage 101 stores a plurality of keys, each of the plurality of keys is configured to activate one or more functions of the electronic device 400. In this embodiment, the keys includes a plurality of different types, in which each type is configured to activate one or more specific functions of the electronic device 400. The key can be a high-bandwidth digital content protection (HDCP) key, a Cinemanow (an Internet-based digital video distribution company) key, a content protector for recordable media (CPRM) key, or the like.

The inputting unit 102 generates instructions in response to manual operations. The inputting unit 102 can be a keyboard, a mouse, a touch screen, a touch pad, a barcode scanner, or the like device.

The setting module 104 sets at least two keys to be written into the electronic device 400 and the key parameters of each of the at least two keys. The key parameters include a storage location of each of the at least two keys in the storage 101, and a name of each of the at least two keys. The setting module 104 further provides a user interface displayed on the display 103 of the key writing device 100 for setting the key parameters. The user interface is configured to receive manual input of the key parameters via the inputting unit 102.

The obtaining module 105 obtains the at least two keys from the storage 101 according to the key parameters. In at least one embodiment, the obtaining module 105 searches the storage 101 according to the storage location and the names of each of the at least two keys to obtain the at least two keys to be written into the electronic device 400.

The packing module 106 packs the obtained keys into a key package. The controlling module 107 controls the key writer 200 to write the key package into the electronic device 400. Thus, each key packed in the key package can be written into the electronic device 400 at the same time, thus saving an unnecessary waste of time of the key writing process of the electronic device 400.

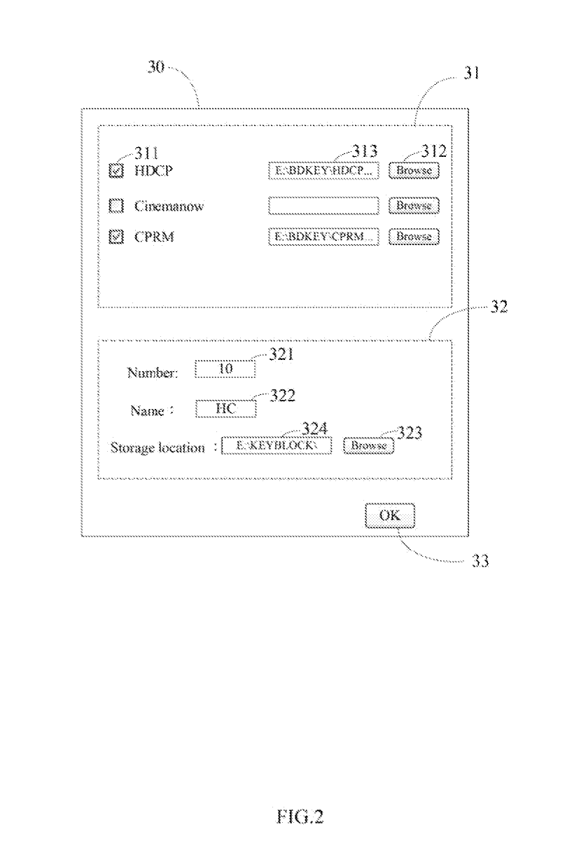

In another embodiment, the setting module 104 further sets packing information for packing the key package. The packing information includes a number of the keys which are needed to be written into the electronic device 400, a name of the packed package, and a storage location where the packed package needs to be stored in the storage 101. FIG. 2 shows a user interface provided by the setting module 104 to set the key parameters and the key information. The user interface 30 comprises a first setting area 31, a second setting area 32, and an OK button 33.

The first setting area 31 includes a selection box 311, a browse button 312 and a display box 313. The selection box 311 selects the at least two keys which need to be written into the electronic device 400. The browse button 312 sets the storage location of each selected key. The display box 313 displays the storage locations of the selected keys. Thus, the key parameters can be manually set using the first setting area 31 of the user interface.

The second setting area 32 includes a first inputting box 321, a second inputting box 322, a second browse button 323, and a second display box 324. The first inputting box 321 receives manual input via the inputting unit 102 for setting the number of the keys which need to be written into the electronic device 400. The second inputting box 322 receives manual input via the inputting unit 102 for setting the name of the packed package. The second browse button 323 sets the storage location where the packed package needs to be stored in the storage 101. The second display box 321 displays the storage location of the packed key package.

The OK button 33 generates an instruction for controlling the obtaining module 105 to obtain the keys from the storage location of the storage 101, when the OK button 33 is operated.

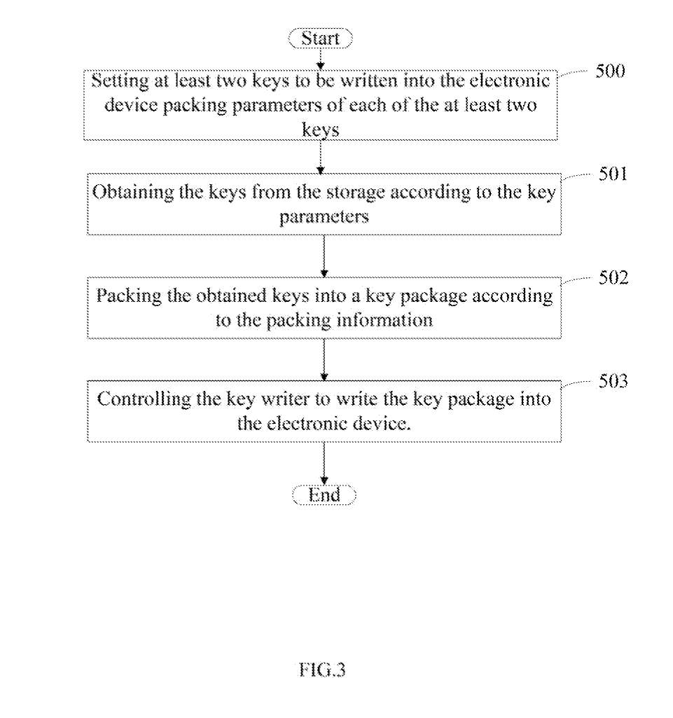

FIG. 3 shows a key writing method for controlling the key writer 200 to write the keys into the electronic device 400. Depending on the embodiment, additional steps can be added, others removed, and the ordering of the steps can be changed.

In 500, setting at least two keys to be written into the electronic device 400 and the key parameters of each of the at least two keys and packing information.

In 501, obtaining the at least two keys from storage according to the key parameters.

In 502, packing the obtained keys into a key package according to the packing information.

In 503, controlling the key writer 200 to write the key package into the electronic device 400.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A key writing device electrically connected to an electronic device via a key writer for writing a plurality of keys into the electronic device, the key writing device comprising:
a storage for storing the plurality of keys, each of the plurality of keys configured to activate one or more functions of the electronic device;
a setting module for setting at least two keys and key parameters of each of the at least two keys;
an obtaining module for obtaining the at least two keys from the storage according to the key parameters;
a packing module for packing the obtained at least two keys into a key package; and
a controlling module for controlling the key writer to write the key package into the electronic device.

2. The key writing device as claimed in claim 1, wherein the key parameters comprise a storage location where each of the at least two keys is stored in the storage, and a key name of each of the at least two keys.

3. The key writing device as claimed in claim 1, wherein the setting module is further configured to set packing information for packing the key package.

4. The key writing device as claimed in claim 3, wherein the packing information comprise a number of the at least two keys which are needed to be written into the electronic device, a name of the packed package, and a storage location where the packed package is stored in the storage.

5. The key writing device as claimed in claim 3, wherein the setting module further provides a user interface displayed on a display of the key writing device for setting the key parameters and the packing information.

6. A key writing method implemented by a key writing device connected to an electronic device via a key writer for writing a plurality of keys into the electronic device, the key writing method comprising:
storing the plurality of keys in a storage of the key writing device, each of the plurality of keys configured to activate one or more function of the electronic device;
setting at least two keys to be written into the electronic device and key parameters of each of the at least two of the keys;
obtaining the at least two keys from the storage according to the key parameters
packing the obtained at least two keys into a key package; and
controlling the key writer to write the key package into the electronic device.

7. The key writing method as claimed in claim 6, wherein the key parameters comprise a storage location where each of the at least two keys is stored in the storage, and a key name of each of the at least two keys.

8. The key writing method as claimed in claim 6, further comprising:
setting packing information for packing the key package.

9. The key writing method as claimed in claim 9, wherein the packing information comprise a number of the at least two keys to be written into the electronic device, a name of the packed package, and a storage location where the packed package is stored in the storage.

10. The key writing device as claimed in claim 8, further comprising:
providing a user interface on a display of the key writing device for setting the key parameters and the key information.
